(19) United States
(12) Patent Application Publication
(10) Pub. No.: US 2005/0155580 A1
(43) Pub. Date: Jul. 21, 2005

(54) Fuel-injection system for an internal combustion engine and method for operating a fuel-injection system

(76) Inventor: Andreas-Juergen Rohatschek, Wernau/Neckar (DE)

Correspondence Address: KENYON & KENYON, ONE BROADWAY, NEW YORK, NY, 10004, US

(21) Appl. No.: 10/510,886

(22) PCT Filed: Apr. 7, 2003
(86) PCT No.: PCT/DE03/01133

(30) Foreign Application Priority Data
Apr. 9, 2002 (DE) 102 15 630.1

(51) Int. Cl. F02M 51/00

(52) U.S. Cl. 123/490

(57) ABSTRACT

In a fuel injection system for an internal combustion engine, e.g., a diesel engine, having at least two cylinders, the fuel injection system having at least two actuator elements and at least one actuator element being assigned to each cylinder for the injection of fuel into the cylinder, and the fuel injection system having an injection control for monitoring and/or resolving a conflict in the triggering of the actuator elements, the injection control triggers the actuator elements earlier and/or later, or not at all, during injections, as a function of the charge and/or discharge edges of the injection elements.

### FIELD OF THE INVENTION

The present invention relates to a fuel injection system for an internal combustion engine, e.g., a diesel engine, having at least two cylinders, the fuel injection system having at least two actuator elements, and at least one actuator element being assigned to each cylinder for the injection of fuel into the cylinder. Furthermore, the present invention relates to a method for operating such a fuel injection system.

### BACKGROUND INFORMATION

German Published Patent Application No. 100 33 343 describes a fuel-injection system for an internal combustion engine, in particular for a diesel engine, which has an injection control system for monitoring and/or solving a conflict in the triggering of the actuator elements, in particular a conflict management of mutually superposed injection processes of piezoactuators.

In piezo common rail actuators only one trigger edge may be implemented simultaneously. However, for reasons of combustion technology it is necessary to apply the triggering of complementary rails such that injections are superposed. Using the circuit device described in German Published Patent Application No. 100 33 343 for the interconnection of piezoelectrical elements, this is possible if the charge/discharge edges of the piezoelectrical elements do not overlap. In the case of overlapping edges, the fuel-injection system described in German Published Patent Application No. 100 33 343 provides that the edge be shifted or shortened in the triggering having low priority (hereinafter referred to as low-priority triggering).

### SUMMARY

According to an example embodiment of the present invention, collisions of trigger edges of different injections may be prevented, while taking the causal correlations into account.

The injection control system may trigger the actuator elements as a function of predefinable time intervals, the time intervals depending on the temporal trigger characteristic of the actuator elements.

An example embodiment of the present invention may provide the specification of time ranges, or time intervals, around the beginning of the trigger edge having higher priority. These time intervals or time ranges may directly determine a maximum displacement/shortening degree of intervals having lower priority with respect to intervals having higher priority. The actuator elements themselves may be piezoelectric elements or also solenoid valves.

According to an example embodiment of the present invention, in a fuel-injection system for an internal combustion engine, e.g., a diesel engine, having at least two cylinders, the fuel-injection system includes at least two piezoelectric elements and each cylinder being assigned at least one piezoelectric element for the injection of fuel into the cylinder by charging or discharging the piezoelectric element. The piezoelectrical elements are assigned a single supply unit for the charging or discharging of the piezoelectrical element. Moreover, the fuel-injection system has an injection control for monitoring a possible overlap of a time interval in which a piezoelectric element is to be charged or discharged, with a time interval in which the other piezoelectric element is to be charged or discharged. Furthermore, at least two injections are assigned different priorities such that one injection is assigned a higher priority (high-priority injection) than at least one other injection (low-priority injection). The injection control may shorten the at least one injection having the lower priority by a predefinable time interval, which is a function of the time characteristic of the charge and discharge of the piezoelectric element or the current through a solenoid valve, the time interval being shortened such that a piezoelectric element will not be charged when the other piezoelectric element is to be charged or discharged, or that no current will flow through the solenoid valve for as long as current is flowing through the other solenoid valve.

Apart from shortening the interval, the injection control may also shift the injection having the lower priority by a time interval that may be predefined and is a function of the time characteristic of the charging and discharging of the piezoelectric element or the current through the solenoid valve, to such a degree that the time interval in which a piezoelectric element is to be charged or discharged does not overlap with the time interval in which the other piezoelectric element is to be charged or discharged.

An example embodiment of a method for operating a fuel-injection system is described herein.

Further aspects and details are derived from the following description of exemplary embodiments with reference to the appended drawings.

### BRIEF DESCRIPTION OF THE DRAWINGS

FIG. 1 illustrates an interconnection configuration of piezoelectric elements.

FIG. 2a illustrates the charging of a piezoelectric element.

FIG. 2b illustrates the charging of a piezoelectric element.

FIG. 2c illustrates the discharging of a piezoelectric element.

FIG. 2d illustrates the discharging of a piezoelectric element.

FIG. 3 illustrates a trigger IC.

FIG. 4 illustrates a chronological sequence of interrupts.

FIG. 5 illustrates a flow chart for conflict management according to an example embodiment of the present invention.

FIG. 6 illustrates a flow chart for a conflict management according to an example embodiment of the present invention.

FIG. 7 illustrates a flow chart for a conflict management according to an example embodiment of the present invention.

### DETAILED DESCRIPTION

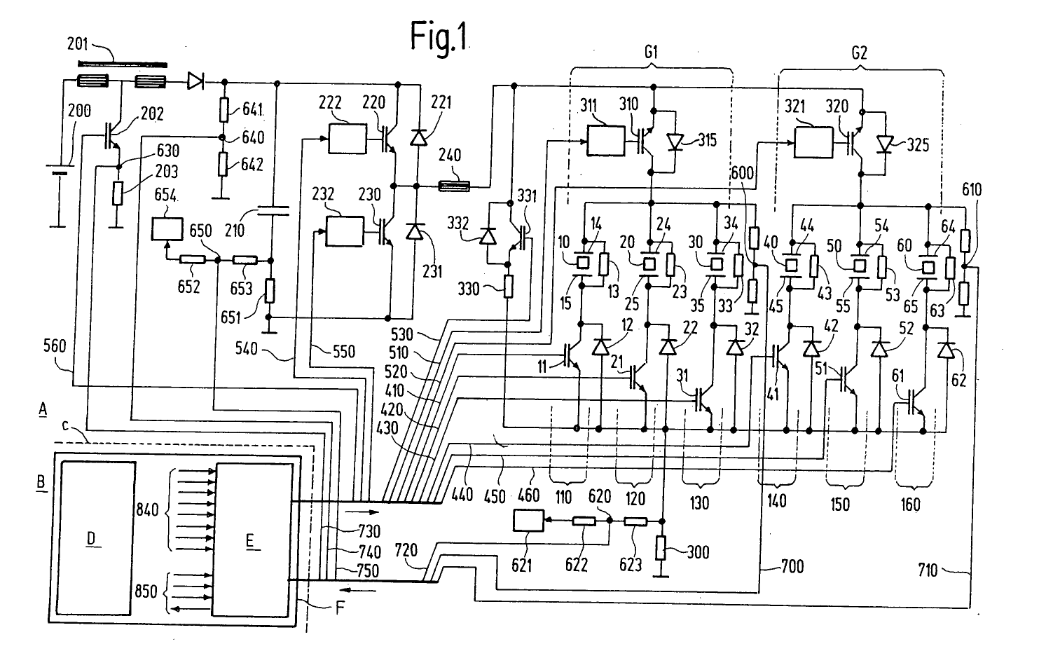

FIG. 1 illustrates piezoelectric elements 10, 20, 30, 40, 50, 60 and means for their triggering. A denotes an area shown in detail, and B an area in an undetailed representation, their separation being indicated by a broken line c. Area A shown in detail includes a circuit arrangement for the charging and discharging of piezoelectric elements 10, 20, 30, 40, 50 and 60. In the viewed example, piezoelectric elements 10, 20, 30, 40, 50 and 60 are actuators in fuel-injection valves (e.g., in so-called common rail injectors) of an internal combustion engine. In the type of example embodiment described, six piezoelectric elements 10, 20, 30, 40, 50 and 60 are used for independently controlling six cylinders inside an internal combustion engine. For other purposes, however, it may be possible to use any other number of piezoelectric elements.

Area B includes injection control system F having a control device D and a trigger IC E used to control the elements within area A, which is shown in detail. Various voltage and current measured values from all of the rest of the triggering circuit of the piezoelectric element are sent to trigger IC E. According to an example embodiment of the present invention, control computer D and trigger IC E are arranged to regulate the triggering voltages and triggering times for the piezoelectric element. Furthermore, control computer D and/or trigger IC E are also arranged to monitor various voltages and currents in the entire triggering circuit of the piezoelectric element. In the description below, the individual elements within area A, which is shown in detail, are described first. A general description of the processes of charging and discharging of piezoelectric elements 10, 20, 30, 40, 50 and 60 will follow. Finally, it will be described in detail how both processes are controlled and monitored by control computer D and trigger IC E.

Piezoelectric elements 10, 20, 30, 40, 50 and 60 are split up into a first group G1 and a second group G2, each of which include three piezoelectric elements (i.e., piezoelectric elements 10, 20, 30 in first group G1 and piezoelectric elements 40, 50 and 60 in group G2). Groups G1 and G2 are parts of circuit elements switched in parallel. Using group select switches 310, 320, it is possible to specify which of the groups G1 (piezoelectric elements 10, 20, 30) and G2 (piezoelectric elements 40, 50, 60) is discharged via a joint charge/discharge device. However, as described in greater detail below, group select switches 310, 320 may be of no significance to charge processes. Piezoelectric elements 10, 20 and 30 of first group G1 are arranged on one actuator bank, and piezoelectric elements 40, 50 and 60 of group G2 are arranged on another actuator bank. Herein, an actuator bank is considered a block on which two or more actuator elements, e.g., piezoelectric elements, are immovably fixed, e.g., encapsulated.

Group select switches 310, 320 are arranged between a coil 240 and groups G1 and G2 respectively (the coil-side connectors thereof) and are arranged as transistors. Drivers 311, 321 are provided, which convert control signals received from trigger IC E into voltages, and which may be selected as required in order to close and open the switches.

Diodes 315 and 325 (designated group select diodes) are arranged in parallel with group select switches 310, 320. If group select switches 310, 320 are arranged as MOSFETs or IGBTs, these group select diodes 315 and 325 may, for example, be arranged as the parasitic diodes themselves. During charge processes, group select switches 310, 320 are bridged by diodes 315, 325. Thus the functionality of group select switches 310, 320 is limited to selecting group G1 (piezoelectric elements 10, 20, 30) or G2 (piezoelectric elements 40, 50 and 60) for a discharge procedure only.

Within groups G1 and G2, piezoelectric elements 10, 20 and 30 and, respectively, 40, 50 and 60 are arranged as components of piezobranches 110, 120 and 130 (group G1) and 140, 150 and 160 (group G2), which are connected in parallel. Each piezobranch includes a series circuit, which includes a first parallel circuit having a piezoelectric element 10, 20, 30, 40, 50, 60 and a resistor 13, 23, 33, 43, 53, 63 (designated a branch resistor) and a second parallel circuit having a select switch (designated a branch select switch) arranged as transistor 11, 21, 31, 41, 51, 61 and a diode 12, 22, 32, 42, 52, 62 (designated a branch diode).

Branch resistors 13, 23, 33, 43, 53 and 63 cause the respective piezoelectric element 10, 20, 30, 40, 50, 60 to discharge continuously during and after a charge process, as they connect both terminals of the capacitive piezoelectric elements 10, 20, 30, 40, 50 and 60 in question. However, branch resistors 13, 23, 33, 43, 53, 63 may be of sufficient size to ensure that this process is carried out slowly as compared with the controlled charge and discharge processes, as described below. Therefore the charge of any piezoelectric element 10, 20, 30, 40, 50 and 60 within a relevant time period following a charge process may be considered constant.

The branch select switches/branch diode pairs in individual piezobranches 110, 120, 130, 140, 150 and 160, i.e., select switch 11 and diode 12 in piezobranch 110, select switch 21 and diode 22 in piezobranch 120, etc., may be implemented as electronic switches (i.e., transistors) having parasitic diodes, e.g., MOSFETs or IGBTs (as indicated above for group select switches/diode pairs 310 and 315 and, respectively, 320 and 325).

Using branch select switches 11, 21, 31, 41, 51 and 61, it is possible to specify which of piezoelectric elements 10, 20, 30, 40, 50 and 60 are charged via a joint charge/discharge device: All piezoelectric elements 10, 20, 30, 40, 50 and 60 whose branch select switches 11, 21, 31, 41, 51 and 61 are closed during the charge procedure described below are charged. Normally, it may not always the case that just one of the branch select switches is closed.

Branch diodes 12, 22, 32, 42, 52 and 62 are used to bridge branch select switches 11, 21, 31, 41, 51 and 61 during discharge processes. Thus, in the example shown, each individual piezoelectric element may be selected for charge processes, whereas in discharge processes either first group G1 (piezoelectric elements 10, 20, 30) or second group G2 (piezoelectric elements 40, 50, 60) or both may be selected.

As for piezoelectric elements 10, 20, 30, 40, 50 and 60 themselves, branch select piezoterminals 15, 25, 35, 45, 55, 65 may be connected to ground, either via branch select switches 11, 21, 31, 41, 51, 61 or via corresponding diodes 12, 22, 32, 42, 52 and 62 and additionally, in both cases, via resistor 300.

The currents flowing between branch select piezoterminals 15, 25, 35, 45, 55, 65 and ground during charging and discharging of piezoelectric elements 10, 20, 30, 40, 50, 60 are measured using resistor 300. Knowledge of these currents allows a controlled charging and discharging of piezoelectric elements 10, 20, 30, 40, 50 and 60. For example, by closing and opening of charging switch 220 or discharging switch 230 as a function of the amount of the current, it may be possible to adjust the charge current or the discharge current to predefined average values and/or to prevent that they exceed or fall below predefined maximum values and/or minimum values.

In the viewed example, a voltage source 621, which provides a voltage of 5 V DC, for example, may additionally be required for the measurement itself, as well as a voltage divider in the form of two resistors 622 and 623. In this manner, trigger IC E (which performs the measurements) is to be protected from negative voltages, which may otherwise occur at measuring point 620 and are not controllable by trigger IC E. Negative voltages of this kind are modified via addition using a positive voltage arrangement supplied by aforementioned voltage source 621 and voltage divider resistors 622 and 623.

The other connection of the particular piezoelectric element 10, 20, 30, 40, 50 and 60, i.e., the respective group-selection piezoterminal 14, 24, 34, 44, 54 and 64, may be connected to the positive pole of a voltage source via group-select switch 310 or 320 or via the group-select diode 315 or 325, as well as via a coil 240 and a parallel connection made up of a charging switch 220 and a charge diode 221. As an alternative or in addition, it may be connected to ground via group-select switch 310 or 320 or via diode 315 or 325 as well as via coil 240 and a parallel connection, made up of a discharging switch 230 and a discharge diode 231. Charging switch 220 and discharging switch 230 are implemented as transistors, for example, which are triggered via drivers 222 and 232, respectively.

The voltage source includes a capacitor 210. Capacitor 210 is charged by a battery 200 (for example, a motor vehicle battery) and by a downstream DC converter 201. DC converter 201 converts the battery voltage (for example, 12 V) into substantially any other DC voltages, for example, 250 V, and charges capacitor 210 to this voltage. DC converter 201 is controlled via transistor switch 202 and resistor 203, which measures the currents tapped at measuring point 630.

For the purposes of cross-checking, a further voltage measurement may be taken at measuring point 650 by trigger IC E and resistors 651, 652 and 653 and, for example, a 5-V DC voltage source 654. Furthermore, a voltage measurement may also be taken at measuring point 640 by trigger IC E and voltage-splitting resistors 641 and 642.

Resistor 330 (designated a total discharge resistor), switch 331 (designated a stop switch) and a diode 332 (designated a total discharge diode) are used to discharge piezoelectric elements 10, 20, 30, 40, 50 and 60 (if, outside the normal operator, as described below, they are not discharged via the abnormal discharge process). Stop switch 331 may be closed following abnormal discharge sequences (cyclical discharging via discharging switch 230) and thus connects piezoelectric elements 10, 20, 30, 40, 50 and 60 to ground via resistors 330 and 300. Thus, any residual voltages possibly left in piezoelectric elements 10, 20, 30, 40, 50 and 60 may be eliminated. Total discharge diode 332 may prevent negative voltages from arising at piezoelectric elements 10, 20, 30, 40, 50 and 60, which may be damaged by negative voltages under certain circumstances.

Charging and discharging of all piezoelectric elements 10, 20, 30, 40, 50 and 60 or of a specific piezoelectric element 10, 20, 30, 40, 50 and 60 is carried out via a single charge/discharge device, which is used jointly for all groups and their piezoelectric elements. In the example shown, the joint charge/discharge device includes battery 200, DC voltage converter 201, capacitor 210, charging switch 220 and discharging switch 230, charge diode 221 and discharge diode 231, as well as coil 240.

Charging and discharging may be carried out in the same manner for each piezoelectric element and is described in the following with reference to only first piezoelectric element 10.

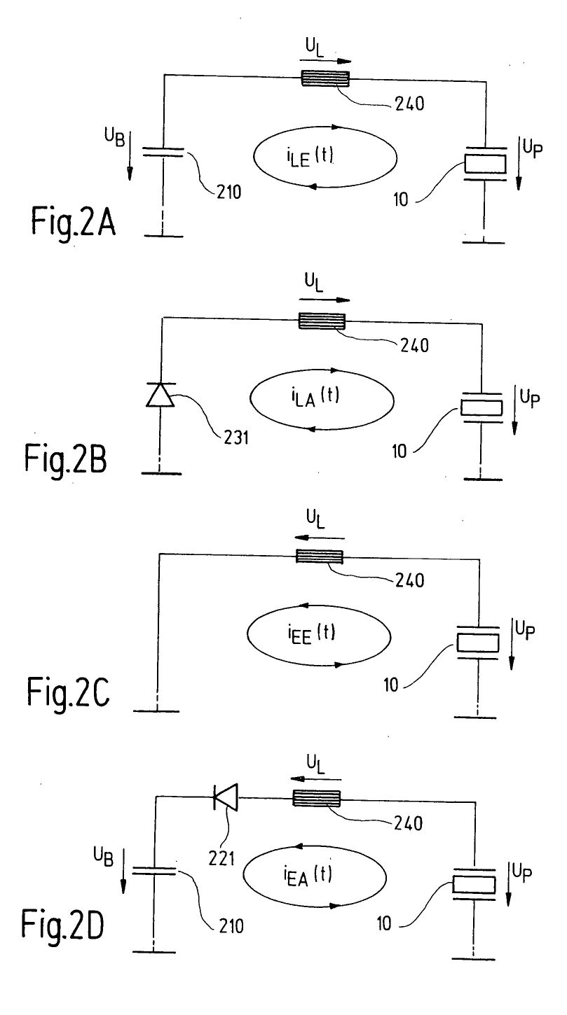

The states arising during the charge and discharge procedures are discussed with reference to FIGS. 2A to 2D. FIGS. 2A and 2B relate to charging of piezoelectric element 10, and FIGS. 2C and 2D relate to discharging of piezoelectric element 10.

The control of the selection of one or a plurality of piezoelectric elements 10, 20, 30, 40, 50 and 60 to be charged or discharged, the charge sequence described below, and the discharge sequence are carried out via trigger IC E and control device D by opening and, respectively, closing of one or a plurality of the aforementioned switches 11, 21, 31, 41, 51, 61; 310, 320; 220, 230, 331. The reciprocal effects between the elements within area A, which is shown in detail, on the one hand, and trigger IC E and control computer D, on the other hand, will be discussed in greater detail in the following.

With regard to the charge sequence, first a piezoelectric element 10, 20, 30, 40, 50, 60 to be charged may be selected. In order to charge just first piezoelectric element 10, branch select switch 11 of first branch 110 is closed, and all other branch select switches 21, 31, 41, 51, 61 remain open. In order to charge any one of the other piezoelectric elements 20, 30, 40, 50, 60 only, or to charge a plurality simultaneously, selection may be carried out by closing the corresponding branch select switches 21, 31, 41, 51, and/or 61.

The charge sequence itself may then be carried out:

In the example shown, as a general rule, a positive potential difference between capacitor 210 and group select piezoterminal 14 of first piezoelectric element 10 may be necessary. However, as long as charging switch 220 and discharging switch 230 are open, no charging or discharging of piezoelectric element 10 takes place. In this state, the circuit illustrated in FIG. 1 is in a steady-state state, i.e., piezoelectric element 10 maintains its charge state substantially unchanged and no currents flow.

To charge first piezoelectric element 10, switch 220 is closed. It may be possible to charge piezoelectric element 10 solely in this manner. However, this may result in substantial currents, which may damage the elements in question. Therefore the currents that arise are measured at measuring point 620 and switch 220 is reopened as soon as the currents detected exceed a specific limit value. In order to achieve a charge as desired on first piezoelectric element 10, charge switch 220 is therefore closed and opened repeatedly, while discharging switch 230 remains open.

Upon closer examination, if charging switch 220 is closed, the situation shown in FIG. 2A will arise, i.e., a closed circuit comes about that includes a series circuit having piezoelectric element 10, capacitor 210 and coil 240, current i_{LE}(t) flowing in the circuit, as shown by the arrows in FIG. 2A. Due to this current flow, positive charges are transferred to group select piezoterminal 14 of first piezoelectric element 10 and power is stored in coil 240.

If charging switch 220 opens briefly, e.g., for a few as following closing, the situation shown in FIG. 2B will arise: A closed circuit comes about that is made up of a series circuit, which includes piezoelectric element 10, discharge diode 231, and coil 240, current i_{LA}(t) flowing in the circuit as indicated by the arrows in FIG. 2B. Due to this current flow, energy stored in coil 240 flows into piezoelectric element 10. In accordance with the energy supply to piezoelectric element 10, the voltage occurring therein increases and the outer dimensions increase. Once energy has been transferred from coil 240 to piezoelectric element 10, the steady-state status of the circuit shown in FIG. 1, which is described earlier, is achieved once again.

At this instant, or earlier or later, depending on the desired time profile of the charge procedure, charging switch 220 is once again closed and reopened so that the sequences described above are carried out once again. Because charging switch 220 is closed and reopened once again, the energy stored in piezoelectric element 10 increases (the energy already stored in piezoelectric element 10 and the energy newly transferred to it are added to one another), and the voltage arising at piezoelectric element 10 increases and its exterior dimensions increase accordingly.

If the aforementioned closing and opening of charging switch 220 is repeated a multitude of times, the voltage arising at piezoelectric element 10 is increased and piezoelectric element 10 expands in a step-by-step manner.

If charging switch 220 has been closed and opened a specific number of times and/or piezoelectric element 10 has reached the desired charge status, charging of the piezoelectric element is ended by leaving charging switch 220 open.

With regard to the discharge sequence, piezoelectric elements 10, 20, 30, 40, 50 and 60 are discharged in groups (G1 and/or G2) in the example shown, as described below:

First, group select switch 310 and/or 320 of group G1 and/or G2 whose piezoelectric elements are to be discharged, are closed (branch select switches 11, 21, 31, 41, 51, 61 have no influence on the selection of piezoelectric elements 10, 20, 30, 40, 50, 60 in the discharge procedure, as they are bridged in this case by diodes 12, 22, 32, 42, 52 and 62). Therefore, in order to discharge piezoelectric element 10 as part of first group G1, group select switch 310 is closed.

If discharging switch 230 is closed, the situation shown in FIG. 2C will arise: A closed circuit comes about that includes a series circuit having piezoelectric element 10 and coil 240, current i_{LE}(t) flowing in the circuit as indicated by the arrows in FIG. 2C. Due to this current flow, the energy (a part thereof) stored in the piezoelectric element is transferred to coil 240. Based on the amount of energy transferred from piezoelectric element 10 to coil 240, the voltage across piezoelectric element 10 drops, and the exterior dimensions thereof decrease.

If charging switch 230 opens briefly, e.g., for a few, as following closing, the situation shown in FIG. 2D arises: A closed circuit will come about which includes a series circuit having piezoelectric element 10, capacitor 210, charge diode 221 and coil 240, current i_{EA}(t) flowing in the circuit as indicated by the arrows in FIG. 2D. Due to this current flow, the energy stored in coil 240 is transferred back to capacitor 210. Once energy has been transferred from coil 240 into capacitor 210, the steady-state status of the circuit, which has already been described and is shown in FIG. 1, is achieved once again.

At this instant, or earlier or later, depending on the desired time profile of the discharge procedure, discharging switch 230 is closed and opened once again so that the aforedescribed sequences are carried out once again. Due to the renewed closing and renewed opening of discharging switch 230, the energy stored in piezoelectric element 10 decreases further and the voltage arising across the piezoelectric element and the exterior dimensions thereof also decrease accordingly.

If the aforementioned closing and opening of discharging switch 230 is repeated a multitude of times, the voltage across piezoelectric element 10 and the expansion of piezoelectric element 10 decrease in a step-by-step manner.

If discharging switch 230 has been closed and opened a specific number of times, and/or the piezoelectric element has reached the desired charge status, discharging of the piezoelectric element is ended by leaving discharging switch 230 open.

The reciprocal action between trigger IC E and control computer D on the one hand and the elements within area A shown in detail on the other hand, is implemented with the aid of control signals which are supplied by trigger IC E to elements within area A shown in detail via branch-selection control lines 410, 420, 430, 440, 450, 460, group-select control lines 510, 520, stop-switch control line 530, charging-switch control line 540 and discharging-switch control line 550 as well as control line 560. On the other side, sensor signals, which are supplied to trigger IC E via sensor lines, 700, 710, 720, 730, 740, 750, are detected at measuring points 600, 610, 620, 630, 640, 650 within area A, which is shown in detail.

For the selection of piezoelectric elements 10, 20, 30, 40, 50, 60 for carrying out charge or discharge sequences for one or a plurality of piezoelectric elements 10, 20, 30, 40, 50, 60 via opening and closing of the corresponding switches as described above, voltages are applied or, respectively, not applied to the transistor bases via the control lines. For example, the sensor signals are used to determine the arising voltage across piezoelectric elements 10, 20, 30 and, respectively, 40, 50, 60 via measuring points 600 and 610 and to determine the charge and discharge currents via measuring point 620.

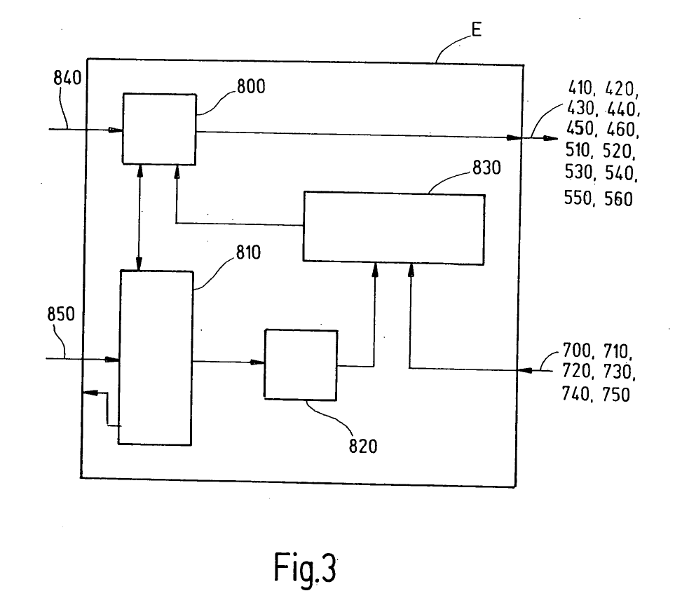

FIG. 3 shows some of the components included in trigger IC E: A logic circuit 800, memory 810, digital-analog converter module 820 and cooperator module 830. Furthermore, it is indicated that the fast parallel bus 840 (used for control signals) is connected to logic circuit 800 of control IC E, while the slower serial bus 850 is connected to memory 810. Logic circuit 800 is connected to memory 810, cooperator module 830, and signal lines 410, 420, 430, 440, 450, 460; 510 and 520; and 530, 540, 550, 560. Memory 810 is connected to logic circuit 800 and digital-analog converter module 820. Furthermore, digital-analog converter module 820 is connected to cooperator module 830. In addition, cooperator module 830 is connected to sensor lines 700 and 710, 720, 730, 740 and 750 and, as already mentioned, to logic circuit 800.

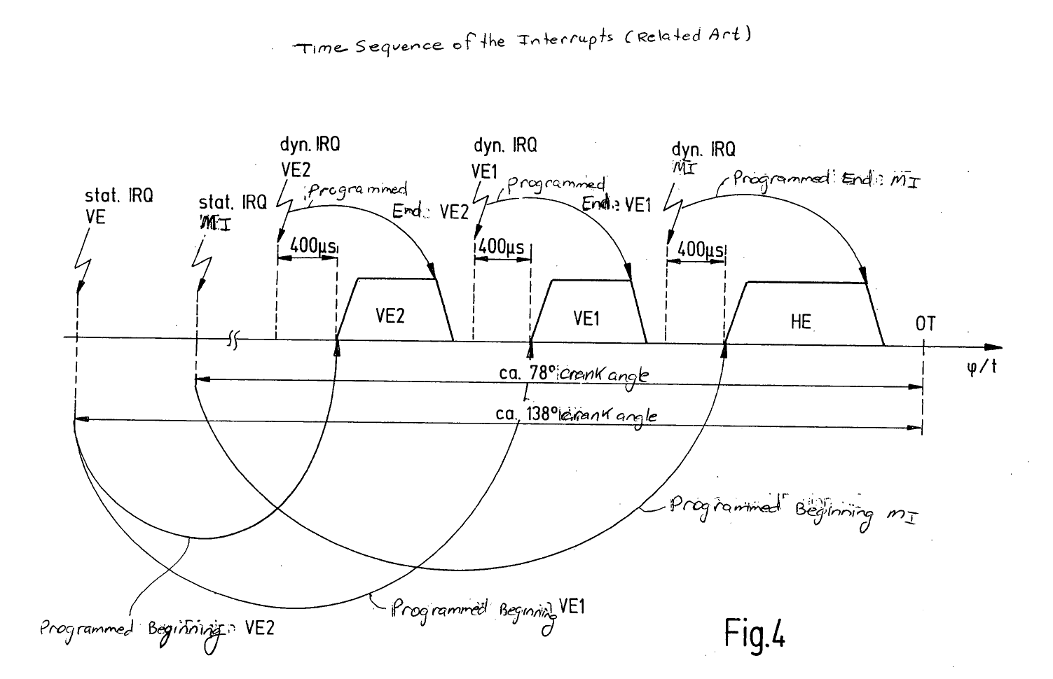

FIG. 4 schematically shows a development over time of interrupts for the programming of the beginning of a main injection HE, which will be described in greater detail in the following, and of two pre-injections VE1 and VE2 as a function of top dead center of the crankshaft as may be conventional. As illustrated in FIG. 4, static interrupts in a 6-cylinder engine are produced at approximately 78° crankshaft, for example, and at approximately 138° crankshaft, for example, thereby programming the beginning of pre-injection 2 and pre-injection VE1 occurring directly ahead of main injection HE. The ends of these injections are then programmed on the basis of dynamic interrupts. It should be understood that the previously mentioned crankshaft angles are merely examples. The interrupts may also be generated at other crankshaft angles.

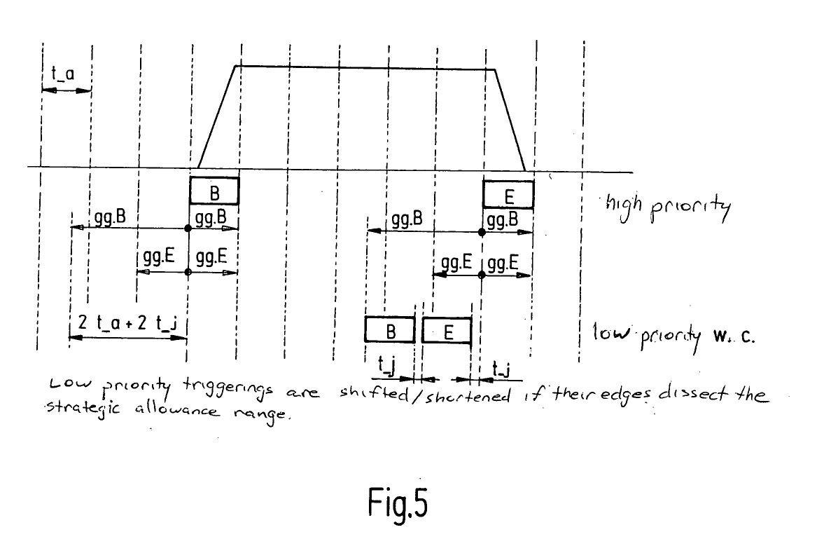

In the context of FIG. 5, a flow chart of a conflict management will be described in the following. Two colliding injections (one injection having high priority, for example a main injection HE, which is denoted by high-priority injection in FIG. 5, and an injection having low priority, such as a pre-injection, which is denoted by low-priority injection in FIG. 5) subdivided. An injection is realized by two trigger edges in the circuit arrangement: a beginning and an end edge, denoted in FIG. 5 by B and E. Starting with the onset of a high-priority edge, “advance” and/or “retard” ranges are established on the time base. If these ranges are dissected by low-priority edges, these edges will be shifted. “Dissecting” means that the beginning of a low-priority edge comes to lie in the area of the time range or time interval designated a strategic lead. If the strategic allowance is oriented to “retard”, only the duration of a high-priority edge, the so-called active time tₐ or also tₐ+tₒ may be safeguarded, tₒ denoting a dynamic allowance, which will be discussed in greater detail below. Therefore, the “safeguard” range (i.e., interval tₐ around the low-priority) with respect to beginning/end edges, is of equal size or differs by tₒ, the active time denoting “processing duration” tₐ according to the circuit shown in FIG. 1, and tₒ the so-called dynamic allowance. This may be selected large enough to cover the most disadvantageous situation, i.e., the longest possible duration. When active time tₐ is established and utilized in the edge or conflict management, the actual duration has not been established yet, since the execution of the edge lies in the future. If the strategic allowance is oriented to “advance”, another distinction is made: If the low-priority edge is an end edge, its distance to the high-priority edge may not exceed its duration. As a result, the range has a length tₐ. If, in the “advance” case, the low-priority edge is a beginning edge, it may be positioned so much in “advance” of, i.e., before, the high-priority edge that in the worst-case scenario a low-priority end edge may lie between this edge and the high-priority edge. This may be necessary for causality reasons, as will be explained in the following. At the time when the beginning edge times are specified according to the static interrupts (cf., FIG. 4), the duration, that is, the interval between the beginning and the end of the edges, has not been established yet. However, once the interval is established, the beginning instant may not be modified anymore. Therefore, already when establishing the beginning instants, it may be ensured that a low-priority end edge fits between low-priority beginning and high-priority edge. For this reason, the safety range with respect to low-priority beginning edges may amount to twice the active time tₐ plus specifiable dynamic intervals tₒ between the edges, for example:
2×active time tₐ+2×dynamic interval tₒ.

Only if it is ensured that the duration (length of interval) as a function of the rail pressure, for example, is large enough for a high-priority edge to fit into this interval even including a dynamic interval, will it be possible to reduce the time interval—the time range in which no onset or end edge may lie—to tₐ.

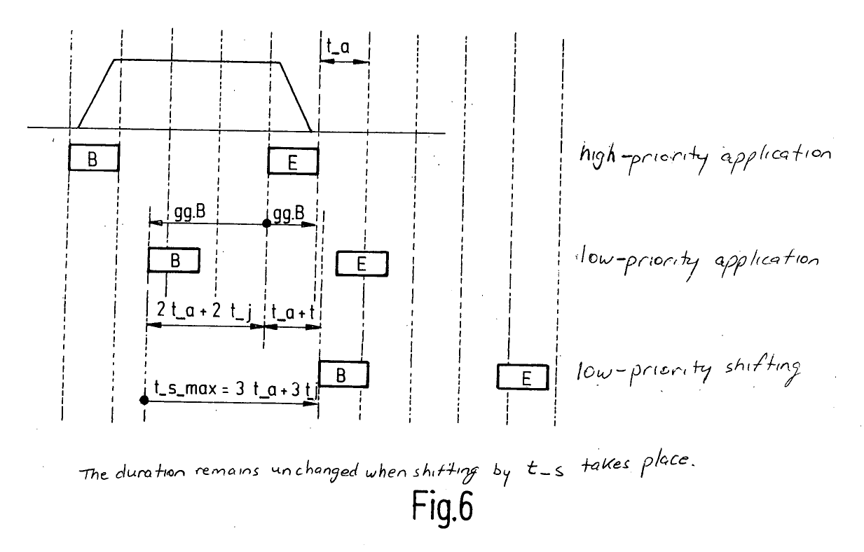

FIG. 6 shows the maximum shifting degree. The low-priority beginning edge is located just close enough to the high-priority end edge for a minimum intersecting area to be given with the time interval referred to as strategic allowance. The low-priority triggering, while maintaining its duration, is shifted to “retard” (i.e., the onset and end edge). After being shifted, the low-priority beginning edge is spaced apart from the high priority by dynamic interval tₒ. Thus, the maximum degree of shift amounts to, for example:
3×active time tₐ+3×dynamic interval tₒ.

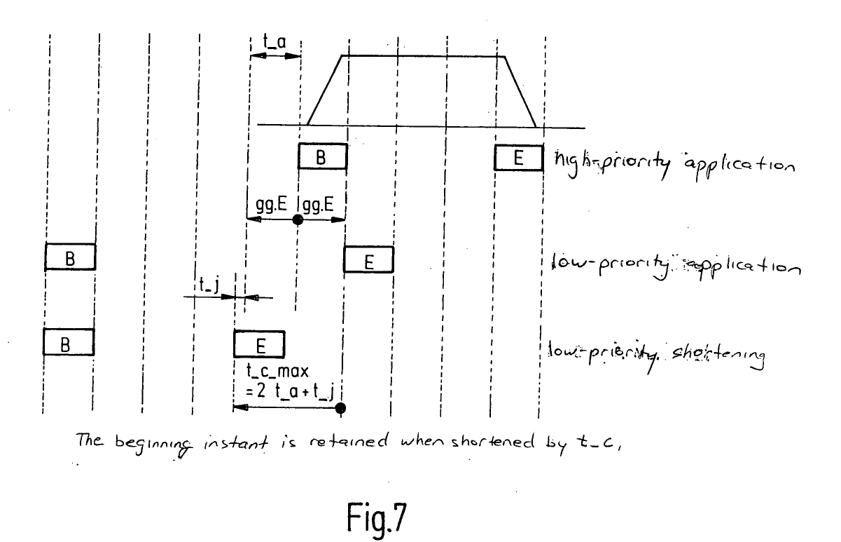

FIG. 7 illustrates the maximum degree of shortening. The low-priority beginning edge is located just close enough to the high-priority beginning edge for a minimal intersecting area to be given with the specified time interval referred to as strategic allowance. Maintaining the low-priority beginning instant, the low-priority end edge, is shifted to “advance”, that is to say, the duration is shortened. After shortening, the low-priority end edge is set apart from the high priority by dynamic interval tₒ. Thus, the maximum degree of shortening amounts to, for example:
2×active time tₐ+dynamic interval tₒ or
2×active time tₐ+2×dynamic interval tₒ.

In general, it applies that the intervals of the beginnings of two edges are spaced apart by active time tₐ and dynamic interval tₒ after having been subjected to edge management.

In the collision of a low-priority beginning edge, a “retard” shift takes place as a rule, since the instants of the beginning edges are specified so as to include sufficient clearance in front of the onset edges in static interrupt, and the collision occurs either with a high-priority beginning edge or a high-priority end edge. In the beginning-beginning case, it is possible to react in static interrupt. In the end-beginning case, the high-priority beginning edge occurs before the low-priority beginning edge for reasons of causality. On this basis, the high-priority duration is determined in the dynamic interrupt of the high-priority triggering, and a shift of the low-priority is possible since its dynamic interrupt and thus the beginning of its processing would have occurred only following the dynamic interrupt of the high priority (cf. FIG. 4). In contrast, in the collision of a low priority end edge, a shortening generally takes place since the collision of this end edge may only be detected when the duration of the low priority triggering in the low priority dynamic interrupt is established and the execution of the beginning edge has thus already begun.

Previously, only primary collisions have been described in connection with FIGS. 5 through 7. Secondary collisions may result from the responses to primary collisions. Secondary collisions are resolved using the same strategic allowances, i.e., are resolved utilizing the same time intervals. The maximum shifting and shortening times increase accordingly.

1-9. (canceled)

10. A fuel injection system for an internal combustion engine, having at least two cylinders, comprising:
at least two actuator elements, at least one actuator element assigned to each cylinder to inject fuel into the cylinder; and
an injection control system configured to at least one of (a) monitor and (b) resolve a conflict in trigger of the at least two actuator elements, the injection control configured to trigger the at least two actuator elements as a function of predefinable time intervals that are a function of a trigger characteristic of at least one of the at least two actuator elements.

11. The fuel-injection system as recited in claim 10, wherein the at least two actuator elements include piezoelectric elements.

12. The fuel-injection system as recited in claim 10, wherein the at least two actuator elements include solenoid valves.

13. A fuel injection system for an internal combustion engine, having at least two cylinders, comprising:
at least two piezoelectric elements, at least one piezoelectric element assigned to each cylinder to inject fuel into the cylinder by one of (a) charging and (b) discharging the at least one piezoelectric element, a single supply unit assigned to the at least two piezoelectric elements to one of (a) charge and (b) discharge the at least two piezoelectric elements;
an injection control system configured to monitor possible overlap of a time interval during which one of the at least two piezoelectric elements is to be one of (a) charged and (b) discharged with a time interval during which another of the at least two piezoelectric elements is to be one of (a) charged and (b) discharged, and at least two injections have different priorities assigned, one injection assigned a higher priority than at least one other injection having a lower priority;
wherein the injection control is configured to shorten the at least one injection having the lower priority by a predefinable time interval as a function of a time characteristic of the charge and discharge of at least one of the at least two piezoelectric elements, the injector control configured so that the piezoelectric element having the lower priority is not charged when the other piezoelectric element having the higher priority is to be one of (a) charged and (b) discharged.

14. The fuel-injection system as recited in claim 13, wherein the injection control is configured to shift the at least one injection having the lower priority by a predefinable time interval which is a function of a time characteristic of at least one of (a) charging and (b) discharging of at least one of the at least two piezoelectric elements, to such an extent that the time interval in which the at least one of the at least two piezoelectric elements is to be one of (a) charged and (b) discharged does not overlap with the time interval in which the other piezoelectric element is to be one of (a) charged and (b) discharged.

15. The fuel-injection system as recited in claim 13, wherein the time characteristic of the predefinable time intervals is a function of a duration of an edge of at least one of the high-priority and the low-priority injection and a predefinable dynamic interval.

16. The fuel-injection system as recited in claim 13, wherein the injection of fuel is configured to be implemented by at least two of the following injections: at least one pre-injection, at least one main injection, and at least one post-injection.

17. A method for operating a fuel injection system for an internal combustion engine having at least two cylinders, the fuel injection system including at least two actuator elements, at least one actuator element assigned to each cylinder for the injection of fuel into the cylinder, comprising:
at least one of (a) monitoring and (b) resolving possible conflicts in triggering of the at least two actuator elements;
wherein the monitoring is implemented as a function of a time characteristic of at least one of (a) charging and (b) discharging of the at least two actuator elements in an injection having at least one of a higher and lower priority.

18. The method for operating as recited in claim 17, wherein the fuel injection system includes at least two piezoelectric elements and at least one piezoelectric element being assigned to each cylinder for the injection of fuel into the cylinder by one of (a) charging and (b) discharging the at least one piezoelectric element, and a single supply unit configured to one of (a) charge and (b) discharge the at least two piezoelectric elements, further comprising:
monitoring whether a time interval, during which one piezoelectric element is to be one of (a) charged and (b) discharged, overlaps with another time interval during which another piezoelectric element is to be one of (a) charged and (b) discharged; and
monitoring whether in a low-priority injection one of (a) charging and (b) discharging occurs within a predefined time interval around a time of one of (a) charging and (b) discharging of a higher priority injection, the predefinable time interval being a function of a time characteristic of one of (a) charging and (b) discharging of the injection having at least one of the higher and lower priority.

19. The fuel-injection system as recited in claim 10, wherein the internal combustion engine is configured as a diesel engine.

20. The fuel-injection system as recited in claim 13, wherein the internal combustion engine is configured as a diesel engine.

21. The method for operating recited in claim 17, wherein the internal combustion engine is configured as a diesel engine.
